(19) United States
(12) Patent Application Publication
(10) Pub. No.: US 2010/0307369 A1
(43) Pub. Date: Dec. 9, 2010

(54) TRAVELWAY STRUCTURE FOR MAGLEV TRANSPORTATION AND A METHOD FOR MANUFACTURING SAME

(75) Inventors: Xiangming Wu, Shanghai (CN); Jingyu Huang, Shanghai (CN); Hongjun Zhang, Shanghai (CN); Jin Shi, Shanghai (CN); Shaozhi Hong, Shanghai (CN)

Correspondence Address: HAMRE, SCHUMANN, MUELLER & LARSON, P.C., P.O. BOX 2902, MINNEAPOLIS, MN, 55402-0902, US

(73) Assignee: Shanghai Maglev Transportation Engineering R&D Center, Shanghai (CN)

(21) Appl. No.: 12/678,900

(22) PCT Filed: Sep. 18, 2007
(86) PCT No.: PCT/CN2007/070720

§ 371 Date: Aug. 24, 2010

(51) Int. Cl. E01B 25/30; B23P 17/00

(52) U.S. Cl. 104/281; 29/527.1

(57) ABSTRACT

The present invention provides a travelway structure for maglev transportation comprises: a travelway girder having a concrete girder plate extending from two sides of the travelway girder; a pre-embedded member pre-embedded in the concrete girder plate; and a detachable member installed on the pre-embedded member via a fastener, wherein the pre-embedded member is machinable, and a position for installing the detachable member on the pre-embedded member is formed by a machining process after the travelway girder experiences deformations which lead to errors. A method for manufacturing a travelway structure for maglev transportation is also provided according to the present invention. Specifically, after a period of time, during which the travelway girder experiences most of the deformations caused by pre-stressed tension and gradual contraction and the like, the travelway girder along with the pre-embedded pieces are moved to the machine tools for machining the functional pre-embedded member. Consequently, the installing position of the detachable members can be precisely formed on the pre-embedded members. According to the present invention, the precision of the functional section of the travelway girder in each construction stage can be distributed reasonably so that the difficulty in controlling the precision of the functional section of the integral travelway girder can be overcome. Further, the defects of high cost, heavy weight, and inconvenience in transportation of the conventional travelway girder can be overcome.

### FIELD OF THE INVENTION

The present invention generally relates to a travelway structure, and more specifically, to a travelway structure for maglev transportation and a method for manufacturing same.

### BACKGROUND

Maglev transportation is a high-speed carrier system. When running at a high speed, the maglev transportation requires a high precision of a supporting structure (i.e., a travelway structure), especially the functional section(s). Currently, according to the types of structures of the functional sections, the structure of the maglev travelway may primarily be categorized into two types described below.

One is a complex girder structure. That is, the functional section(s) and the girder are manufactured separately. DE19841936.8-25 and DE0987370A1 describe such structures, in which the functional section is in steel structure, with each functional surface being manufactured and machined independently. After pre-embedding a connector in the concrete girder, the girder may be deformed, when the concrete is being solidified and during a time of period thereafter, due to factors such as pre-stressed tension and gradual contraction. After the occurrence of the deformations, a machining process is performed on the connecting surface of the connector. Then, the functional section of the steel structure and the concrete girder are combined together. Although such approach may help to reduce the requirement for the mold manufacturing process and may easily control the deformation of the concrete girder before machining, the approach has the following defects.

(1) The functional section and the girder cannot form a consolidated structure which can accept stress integrally, since the functional section and the girder are not formed integrally.

(2) The body of the complex girder structure is heavy in weight and thus can not meet the transportation requirement of a long trunk line.

(3) The functional section is made of a steel material which may result in a high cost for building the complex girder.

To overcome the heavy weight and high cost of the complex girder structure, a consolidated or integral travelway structure, in which the functional section and the girder are combined during the manufacturing process, is proposed. WO2006005676 proposes a method for integrally manufacturing the functional section and the girder by using concrete. Then, a detachable member such as a stator or a guiding plate is fastened, in a bolt-connecting manner, directly to a stator supporting surface or a guiding plate supporting surface located on the concrete travelway girder. Since the position for installing each detachable member on the supporting surface is formed precisely when the concrete travelway girder is being manufactured, there is no need to perform a machining process to form the position for installing the detachable member when the detachable member is being installed. According to a computational analysis, since the functional section has become a part of the girder body, it provides a certain extent of rigidity to the whole structure and the weight of the girder body is reduced. Moreover, since the functional section is made of concrete, the material cost is reduced. The main defects of such a structure are as follows.

(1) Since the position for installing the detachable member has been already located or positioned precisely when the travelway girder is being manufactured, it is difficult to control the positional offset of the functional surface of the girder body, which is caused by the deformation due to tension, gradual contraction and the like. Therefore, it is difficult to meet the technical standards for positioning the detachable member, especially for a long girder and a bent girder.

(2) Due to the tolerance of the supporting surface of the detachable member, the position for installing the fastener has to be adjusted by the girder mold. Therefore, the requirement for construction process is raised.

### SUMMARY

To overcome the above-mentioned problems, the present invention is to provide a travelway structure for maglev transportation and a method for manufacturing same. Such a travelway structure is conducive to error control and convenience in construction, and can meet the transportation requirement of a long trunk line.

The main idea of the present invention is described as follows.

A pre-embedded member which satisfies the strength requirement is pre-embedded in a concrete integral travelway girder so as to connect with a detachable member. Thus, by taking full advantage of the integral travelway girder which can integrally accept stress, the weight and cost can be reduced. Since the pre-embedded member is machined only after most of the time-variant effects caused by the pre-stress tension, gradual contraction and the like occur. Then, the detachable member is positioned and installed. Therefore, construction is made easier by machining, just like the complex girder, and thereby eliminating the offset errors of the functional surface caused by subsequent deformations.

Technical solutions of the present invention are as follows.

A travelway structure for maglev transportation, comprising: a travelway girder having a concrete girder plate extending from two sides of the travelway girder; a pre-embedded member pre-embedded in the concrete girder plate; and a detachable member installed on the pre-embedded member via a fastener, wherein the pre-embedded member is machinable, and a position for installing the detachable member on the pre-embedded member is formed by a machining process after the travelway girder experiences deformations which lead to errors.

A method for manufacturing a travelway for maglev transportation, comprising: manufacturing a pre-embedded member with a machinable material; arranging the pre-embedded member into a mold for the travelway girder by a rough positioning; forming the travelway girder by pouring concrete; and moving, after a time of period during which the travelway girder experiences deformations which lead to errors, the travelway girder along with the pre-embedded member to machine tools for machining a functional pre-embedded member; forming a precise position for installing a detachable member on the pre-embedded member; and installing the detachable member to the pre-embedded member via a fastener.

Technical effects of the present invention are as follows.

(1) According to the present invention, the pre-embedded member in the travelway girder is initially positioned so as to meet the requirement of rough positioning. Then, a machining process is performed after most of the deformations, such as pre-stress tension, gradual contraction, occur. Precise installation and positioning is thus achieved. Consequently, the precision of the functional section of the travelway girder in each construction stage is distributed reasonably so that the difficulty in controlling the precision of the functional section of the integral travelway girder can be overcome.

(2) According to the present invention, the functional section(s) has become a part of the travelway girder. The functional section accepts the stress along with the integral structure and fully utilizes the machinability of the pre-embedded member such that the defects of high cost, heavy weight, and difficulty in transportation of the complex travelway girder can be overcome, while the advantage of the controllable precision of the functional surface of the complex travelway girder is preserved.

(3) It is easier for the travelway structure manufactured according to the present invention to meet each technical standard and the transportation requirement as well.

### BRIEF DESCRIPTION OF THE DRAWINGS

FIG. 1 illustrates a cross-section view of a travelway structure according to a first embodiment of the present invention;

FIG. 2 illustrates a partial enlarged cross-section view of the above-described travelway structure;

FIG. 3 illustrates a partial enlarged cross-section view of a travelway structure according to a second embodiment of the present invention;

FIG. 4 illustrates a diagram of a pre-embedded member for the stator;

FIG. 5 illustrates a diagram of a pre-embedded member for the guiding plate; and

FIG. 6 illustrates a diagram of a machined surface of the pre-embedded member.

### DETAILED DESCRIPTION

Detailed description will be made to the travelway structure of the present invention, when taken in conjunction with the accompanying drawings. In the drawings, each identical component that is illustrated in various figures is represented by a like numeral.

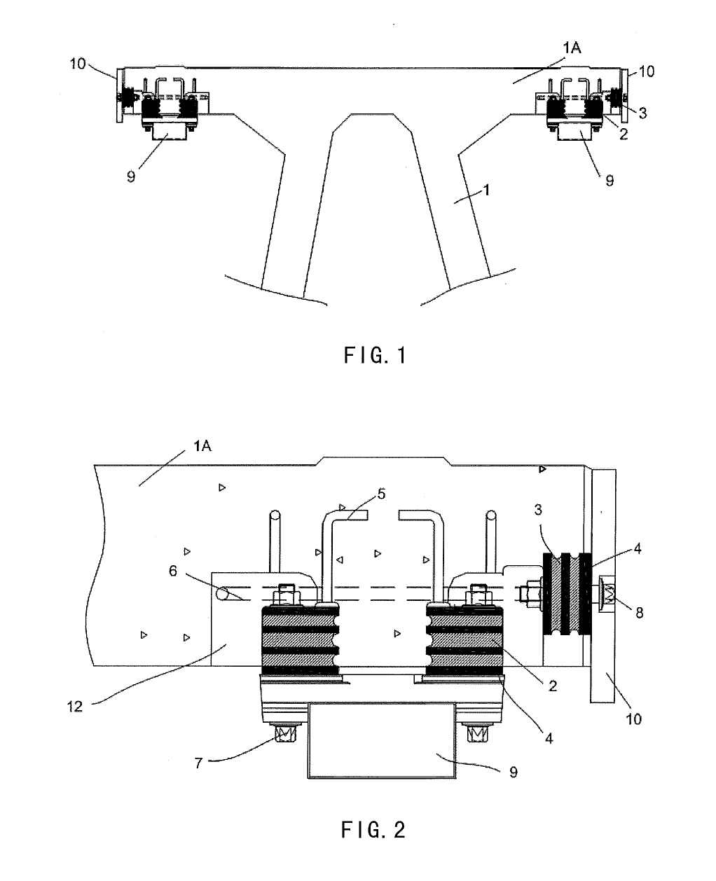

As illustrated in FIG. 1, the travelway structure according to the first embodiment of the present invention mainly includes a travelway girder 1 and detachable members positioned on the travelway guider. Preferably, the travelway girder 1 may be a pre-stressed steel-reinforced concrete girder with a concrete girder plate 1A extending from two sides. Stators 9, as a detachable member, are positioned on the lower surface of the girder plate 1A. Guiding plates 10, as a detachable member, are positioned on the two sides of the girder plate 1A.

Referring to FIG. 2, a pre-embedded member 2 for the stator and a pre-embedded member 3 for the guiding plate 3 are pre-embedded at predetermined positions spaced apart along a longitudinal direction of the girder plate 1A. The pre-embedded member 2 for the stator includes two pre-embedded pieces. The pre-embedded member 2 for the stator and the pre-embedded member 3 for the guiding plate 3 are pre-embedded pieces which can be machined. For instance, the guiding plate supporting surface 4 of the pre-embedded member 3 has a machining allowance or margin for machining. Moreover, to enhance the connection strength between the pre-embedded members and the concrete girder plate 1A, anchoring reinforcing steel bars 5 and 6 are preferably provided on the pre-embedded member 2 for the stator and the pre-embedded member 3 for the guiding plate, respectively. The stator 9 is detachably coupled to the pre-embedded member 2 via a bolt 7. The guiding plate 10 is detachably coupled to the pre-embedded member 3 via a bolt 8.

According to the present invention, when the pre-embedded members are buried into the travelway guider 1, it is not highly demanding for the positions of the pre-embedded members so long as the requirement for a rough position is met. In other words, only “rough positioning” is required when the pre-embedded pieces are arranged into the mold for the travelway girder. “Rough positioning” refers to a level of positioning precision which can be reached via a conventional civil construction technique. “Rough positioning” does not require a precise positioning which requires directly connecting to the detachable members. Then, the travelway girder 1 is formed by pouring the concrete. After a time of period, during which the travelway girder 1 experiences quite a lot of deformations caused by, for example, the pre-stressed tension and the gradual contraction, the travelway girder together with the pre-embedded members are moved to the machine tools for performing machining on the pre-embedded members, such as cutting, milling, grinding, and drilling and the like. Thus, the installation positions for the stator 9 and the guiding plate 10 can be formed precisely on the pre-embedded members. Finally, the bolts 7, 8 are used to couple the stator 9 and the guiding plate 10 to the pre-embedded members. That is, the stators 9 and 10 are thus installed on the travelway girder 1.

In addition, to facilitate the installation of the stator 9, a handhole 12 is preferably provided around the pre-embedded member 2 for the stator on the travelway girder 1. Similarly, a handhole is also preferably provided around the pre-embedded member 3 for the guiding plate.

In the present invention, since the machining is performed after most of the deformations, such as those caused by pre-stressed tension, gradual contraction of the travelway girder, occurs, the detachable members can be precisely positioned and installed. Consequently, the problem that the precision of the functional section of the travelway girder can not be easily controlled has been overcome. In addition, the travelway structure is imbued with extra low cast, light weight, and easy transportation.

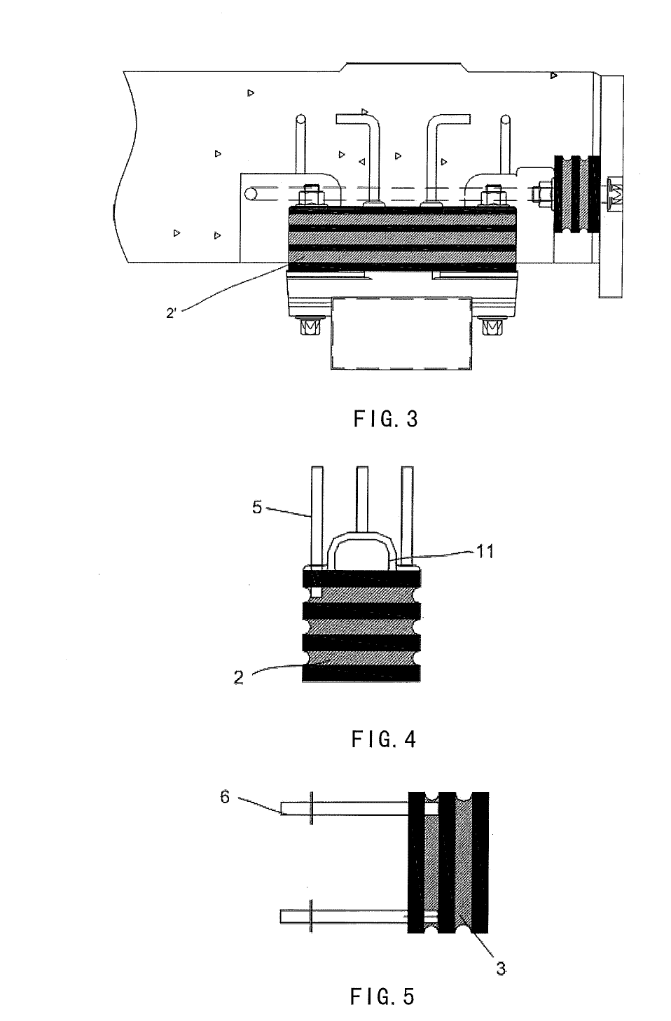

FIG. 3 illustrates a travelway structure according to a second embodiment of the present invention. The second embodiment differs from the first embodiment in that the pre-embedded member 2′ for the stator includes only one pre-embedded piece.

FIG. 4 illustrates a diagram of a pre-embedded member 2 for the stator. The pre-embedded member 2 for the stator may be designed into a variety of forms, with different amounts, shapes, and sizes. The shape and the size are designed such that the pre-embedded member 2 may tolerate the errors due to the rough positioning of the pre-embedded member and the error range of the gradual contraction of the girder. The pre-embedded member 2 for the stator may be a machinable pre-embedded member which meets the strength requirement. The pre-embedded member 2 for the stator may be made of ductile iron casting, steel, composite material and the like. Generally, the pre-embedded member 2 for stator and the anchoring reinforcing steel bar 5 are connected to each other via a bolt or via welding. Further, to strengthen the connectivity, the front end of the anchoring reinforcing steel bar 5 may be provided with a button-head or a bending portion as desired. To facilitate construction, a handhole 11 can also be provided on the pre-embedded member 2 for the stator.

FIG. 5 illustrates a diagram of a pre-embedded member 3 for the guiding plate. The pre-embedded member 3 for the guiding plate may be designed into a variety of forms, with different amounts, shapes, and sizes. The shape and the size are designed such that the pre-embedded member 3 for the guiding plate may tolerate the errors due to the rough positioning of the pre-embedded member 3 and the error range of the gradual contraction of the girder. Similarly, the pre-embedded member 3 for the guiding plate may be a machinable pre-embedded member which meets the strength requirement. Such a pre-embedded guiding plate 3 may be made of ductile iron casting, steel, composite material and the like. Generally, the pre-embedded member 3 for guiding plate and the anchoring reinforcing steel bar 6 are connected to each other via a bolt or via welding. In addition, the front end of the anchoring reinforcing steel bar 6 may be provided with a button-head or a bending portion as desired.

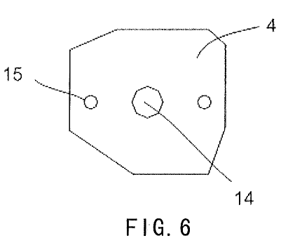

FIG. 6 illustrates a diagram of a machined surface of the pre-embedded members. The supporting surface 4 (machined surface) may be cut or ground by machine tools so as to meet the precision requirements. The installation position for the stator or the guiding plate may be precisely formed by drilling a hole 14 by the machine tools. Of course, if the supporting surface 4 is precise enough, a hole can be drilled directly without cutting or grinding. Moreover, in order to securely fasten the pre-embedded members to the mold for the concrete travelway girder, it is Preferable to provide on the pre-embedded pieces with a plurality of holes 15 through which fasteners may pass.

Although the travelway structure of the present invention is described in connection with preferred embodiments, it is appreciated that variations and modifications can be made based on the above disclosure by an ordinary person skilled in the art. For instance, although only two detachable members, i.e., stator 9 and guiding plate 10, are described in the present invention, the detachable members, however, are not limited to the stator and the guiding plate. Some other components may be employed, for example, sliding rails on two sides of the upper surface of the girder plate 1A. Different detachable members may correspond to different pre-embedded members. Therefore, the scope of the present invention shall not be limited to those described above. Rather, the scope of the present invention is to be determined by the appended claims.

1. A travelway structure for maglev transportation, comprising: a travelway girder having a concrete girder plate extending from two sides of the travelway girder; a pre-embedded member pre-embedded in the concrete girder plate; and a detachable member installed on the pre-embedded member via a fastener, characterized in that, the pre-embedded member is machinable, and a position for installing the detachable member on the pre-embedded member is formed by a machining process after the travelway girder experiences deformations which lead to errors.

2. The travelway structure of claim 1, characterized in that, the pre-embedded member includes a supporting surface with a machining allowance or margin.

3. The travelway structure of claim 1, characterized in that, the machining includes at least one of cutting, drilling, and hole-drilling.

4. The travelway structure of claim 2, characterized in that, the supporting surface is provided with a hole through which the fastener passes.

5. The travelway structure of claim 1, characterized in that, the pre-embedded member includes an anchoring member.

6. The travelway structure of claim 5, characterized in that, a front end of the anchoring member includes a button-head or a bending portion.

7. The travelway structure of claim 1, characterized in that, a handhole is provided around the pre-embedded member in the travelway girder.

8. The travelway structure of claim 1, characterized in that, the pre-embedded member is provided with a handhole.

9. The travelway structure of claim 1, characterized in that, the detachable member includes a stator and a guiding plate, and the pre-embedded member includes a pre-embedded member for the stator and a pre-embedded member for the guiding plate.

10. A method for manufacturing a travelway for maglev transportation, comprising:
manufacturing a pre-embedded member with a machinable material;
arranging the pre-embedded member into a mold for the travelway girder by a rough positioning;
forming the travelway girder by pouring concrete, the travelway having a concrete girder plate extending from two sides of the travelway girder, the pre-embedded member being pre-embedded in the concrete girder plate; and
moving, after a time of period during which the travelway girder experiences deformations which lead to errors, the travelway girder along with the pre-embedded member to machine tools for machining a functional pre-embedded member;
forming a precise position for installing a detachable member on the pre-embedded member; and
installing the detachable member to the pre-embedded member via a fastener.
